(19) United States
(12) Patent Application Publication
(10) Pub. No.: US 2021/0278235 A1
(43) Pub. Date: Sep. 9, 2021

(54) PERSONAL MOBILITY AND CONTROL METHOD THEREOF

(71) Applicants: HYUNDAI MOTOR COMPANY, Seoul (KR); KIA MOTORS CORPORATION, Seoul (KR)

(72) Inventors: Seunghyun Woo, Seoul (KR); Minjae Park, Seongnam-si (KR); Jong Bok Lee, Yongin-si (KR)

(21) Appl. No.: 17/082,354

(22) Filed: Oct. 28, 2020

(30) Foreign Application Priority Data
Mar. 5, 2020 (KR) 10-2020-0027887

(51) Int. Cl. G01C 21/36; G08G 1/0968; G08G 1/052; B62J 50/22; B62J 45/422

(52) U.S. Cl. CPC G01C 21/3632; G08G 1/096827; B62J 45/422; B62J 50/22; G08G 1/052

(57) ABSTRACT

In accordance with one aspect of the disclosure, a personal mobility which can efficiently transmit various information to a driver by a the transformable element provided in a handle includes: the handle; the transformable unit provided on the handle and configured to change a shape according to a control signal; a storage configured to store a plurality of shapes corresponding to a plurality of instructions for guiding a driving direction of personal mobility; and a controller configured to receive a driving direction calculated based on a current position and a destination of the personal mobility and determine and send the control signal to the transformable unit to change the transformable unit into a shape corresponding to an instruction for guiding the received driving direction among the plurality of instructions.

### CROSS-REFERENCE TO RELATED APPLICATION

This application is based on and claims priority under 35 U.S.C. § 119 to Korean Patent Application No. 10-2020-0027887, filed on Mar. 5, 2020 in the Korean Intellectual Property Office, the disclosure of which is incorporated herein by reference.

### TECHNICAL FIELD

The disclosure relates to a personal mobility, which is a small transportation mean, and a control method thereof.

### BACKGROUND

Recently, the use and spread of small-sized transportation means that can drive not only roads, but also sidewalks, bicycle paths, narrow alleys, etc. using electricity as power have been expanded.

Such small-sized transportation means include an electric kick board, an electric wheel, and an electric bicycle, and this is referred to as personal mobility.

Personal mobility needs to inform the driver of various information such as the state of personal mobility or the driving direction.

However, since a driver of personal mobility manipulates personal mobility in a state exposed to an external environment, it is difficult for personal mobility to provide the above various types of information to the driver.

For example, when personal mobility outputs various information using a display, the driver many not recognize the information output on the display due to sunlight directly irradiated on the display, and when personal mobility outputs various types of information using the speaker, the driver may not recognize the information output from the speaker due to external noise.

### SUMMARY

Therefore, it is an aspect of the present disclosure to provide a personal mobility that can provide various information to a driver of personal mobility by using a transformable element provided in a handle of personal mobility, and a control method thereof.

In accordance with one aspect of the disclosure, a personal mobility includes: a handle; a transformable unit provided on the handle and configured to change a shape according to a control signal; a storage configured to store a plurality of shapes corresponding to a plurality of instructions for guiding a driving direction of personal mobility; and a controller configured to receive a driving direction calculated based on a current position and a destination of the personal mobility and determine and send the control signal to the transformable unit to change the transformable unit into a shape corresponding to an instruction for guiding the received driving direction among the plurality of instructions.

The storage may be configured to store a plurality of shapes corresponding to a plurality of states of the personal mobility, and the controller may be configured to change the transformable unit into a shape corresponding to one state when the one state of the plurality of states is detected.

The controller may be configured to change the transformable unit into a shape corresponding to a state having a higher priority among at least two states when the at least two states of the plurality of states are detected.

When any one of the plurality of states is detected and the driving direction calculated based on the current position and the destination of the personal mobility is received, the controller may be configured to change the transformable unit into a shape corresponding to a higher priority among the detected state and the instruction for guiding the driving direction.

The plurality of instructions for guiding the driving direction may include an instruction for at least one of a left turn, a right turn, a going straight, or a U-turn.

The plurality of states of the personal mobility may include at least one of a state in which one of components of the personal mobility has failed, a state in which a SoC (State of Charge) of the personal mobility is less than or equal to a preset level, a state in which a driving speed of the personal mobility is more than or equal to a preset speed, or a state in which the current position of the personal mobility is outside a preset area.

The handle may include a left handle and a right handle, the transformable unit may include a first transformable element provided on the left handle and a second transformable element provided on the right handle, and the controller may be configured to independently change the first transformable element and the second transformable element.

The controller may be configured to determine a contact area in which the driver's hand and the transformable unit are in contact based on a capacitance of the transformable unit, and change a shape of the transformable unit within the contact area.

The plurality of shapes corresponding to the plurality of instructions may include at least one of a static shape or a dynamic shape that changes over time.

The controller may be configured to determine a current intensity applied to the transformable unit based on the size of the contact area.

In accordance with one aspect of the disclosure, a control method of a personal mobility including a handle, a transformable unit provided on the handle and configured to change a shape according to a control signal and a storage configured to store a plurality of shapes corresponding to a plurality of instructions for guiding a driving direction of personal mobility, the method includes: receiving a driving direction calculated based on a current position and a destination of the personal mobility; and changing the transformable unit into a shape corresponding to an instruction for guiding the received driving direction among the plurality of instructions within an area.

The storage may be configured to store a plurality of shapes corresponding to a plurality of states of the personal mobility, and the control method may further include: detecting whether the personal mobility corresponds to one state of the plurality of states; and changing the transformable unit into a shape corresponding to the one state when the one state of the plurality of states is detected.

The control method may further include: changing the transformable unit into a shape corresponding to a state having a high priority among the detected at least two states when at least two states of the plurality of states are detected.

The changing the transformable unit may include: determining a contact area in which the drivers hand and the transformable unit are in contact based on a capacitance of the transformable unit, and changing a shape of the transformable unit within the contact area.

The changing the transformable unit may include: determining a current intensity applied to the transformable unit based on the size of the contact area.

In accordance with another aspect of the disclosure, a personal mobility includes: a handle; a transformable unit provided on the handle and configured to change a shape according to a control signal; a storage configured to store a plurality of shapes corresponding to a plurality of states of the personal mobility; and a controller configured to determine and send the control signal to the transformable unit to change the transformable unit into a shape corresponding to one state when the one state of the plurality of states is detected.

The controller may be configured to change the transformable unit into a shape corresponding to a state having a higher priority among at least two states when the at least two states of the plurality of states are detected.

The plurality of states of the personal mobility may include at least one of a state in which one of components of the personal mobility has failed, a state in which a SoC of the personal mobility is less than or equal to a preset level, a state in which a driving speed of the personal mobility is more than or equal to a preset speed, or a state in which the current position of the personal mobility is outside a preset area.

The handle may include a left handle and a right handle, the transformable unit may include a first transformable element provided on the left handle and a second transformable element provided on the right handle, and the controller may be configured to independently change the first transformable element and the second transformable element.

The controller may be configured to determine a contact area in which the driver's hand and the transformable unit are in contact based on a capacitance of the transformable unit, and change a shape of the transformable unit within the contact area.

The plurality of shapes corresponding to the plurality of states may include at least one of a static shape or a dynamic shape that changes over time.

The controller may be configured to determine a current intensity applied to the transformable unit based on a size of the contact area.

The transformable unit may be provided to protrude on the handle.

The transformable unit may include: a fixed portion fixed on the handle; and a transformable portion whose shape changes in a direction perpendicular to the fixed portion.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an example illustrating an appearance of personal mobility according to an embodiment.

FIG. 2 is a bird's-eye view of a handle of personal mobility according to an embodiment.

FIG. 3 is a side view of a handle of personal mobility according to an embodiment.

FIG. 4 is a control block diagram of personal mobility according to an embodiment.

FIG. 5 is a flowchart illustrating a control method of personal mobility according to an embodiment.

FIG. 6 is a diagram illustrating a plurality of shapes corresponding to a plurality of states of personal mobility and a plurality of instructions for guiding a driving direction of personal mobility.

FIG. 7 is a diagram illustrating a shape of a transformable element when an instruction for right turn is received in personal mobility according to an embodiment.

FIG. 8 is a diagram illustrating a shape of a transformable element when a SoC of personal mobility is insufficient according to an embodiment.

### DETAILED DESCRIPTION

Like reference numerals refer to like elements throughout the specification. Not all elements of embodiments of the disclosure will be described, and description of what are commonly known in the art or what overlap each other in the embodiments will be omitted.

It will be understood that when an element is referred to as being “connected” to another element, it can be directly or indirectly connected to the other element, wherein the indirect connection includes “connection” via a wireless communication network.

Also, when a part “includes” or “comprises” an element, unless there is a particular description contrary thereto, the part may further include other elements, not excluding the other elements.

As used herein, the singular forms “a,” “an” and “the” are intended to include the plural forms as well, unless the context clearly indicates otherwise.

As used herein, the terms “portion,” “unit,” “block,” “member,” and “module” refer to a unit that can perform at least one function or operation. For example, these terms may refer to at least one process which is performed by at least one piece of hardware such as a field-programmable gate array (FPGA) and an application specific integrated circuit (ASIC), and at least one piece of software stored in a memory or a processor.

An identification code is used for the convenience of the description but is not intended to illustrate the order of each step. Each of the steps may be implemented in an order different from the illustrated order unless the context clearly indicates otherwise.

Hereinafter, embodiments of a personal mobility and a control method thereof according to an aspect will be described in detail with reference to the accompanying drawings.

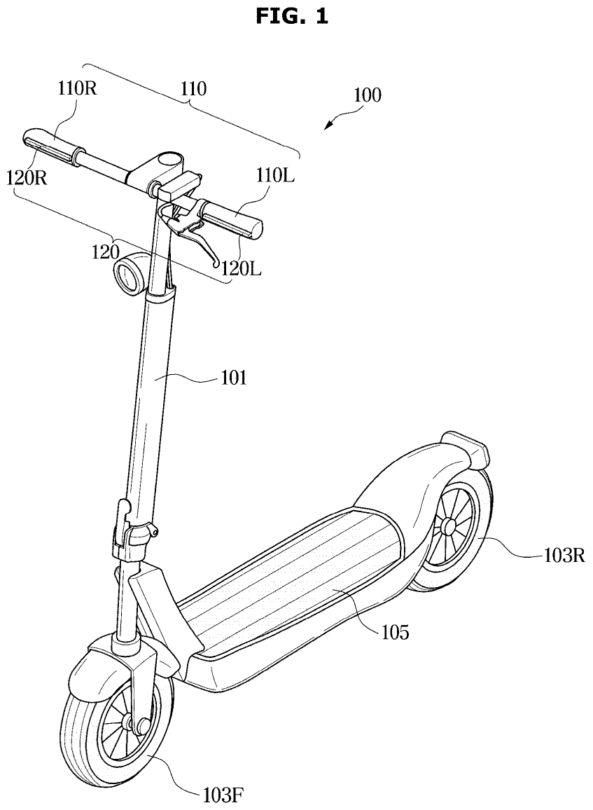

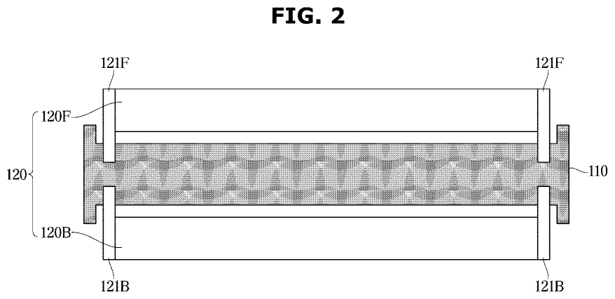

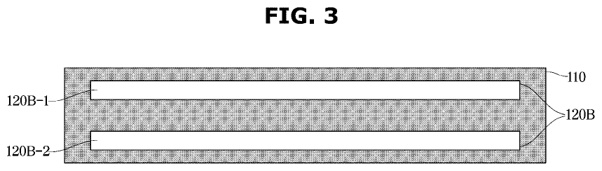

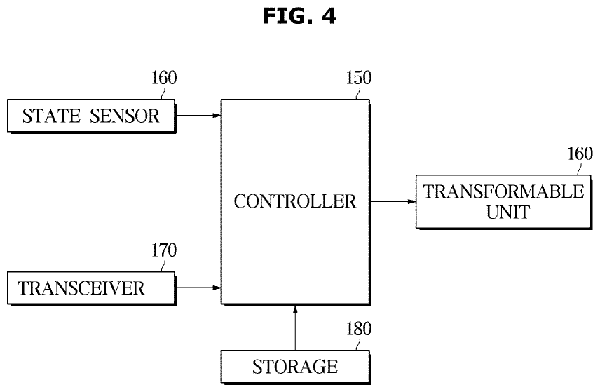

FIG. 1 is an example illustrating an appearance of personal mobility according to an embodiment. FIG. 2 is a bird's-eye view of a handle of personal mobility according to an embodiment. FIG. 3 is a side view of a handle of personal mobility according to an embodiment. FIG. 4 is a control block diagram of personal mobility according to an embodiment.

Personal mobility 100 according to an embodiment means a small mobility means for one person or two persons capable of driving with electric power such as an electric kickboard, an electric scooter, an electric skateboard, an electric bicycle, or an electric wheel. The type of personal mobility 100 is not limited to the above example, and includes without limitation any small mobility means powered by electricity. The personal mobility 100 as a transportation tool, powered by electricity such as a battery, may be operated and ridden by a user to move the user from one location to another location. For a detailed description, in the embodiment described below, a case in which personal mobility is an electric kickboard will be described as an example.

Referring to FIG. 1, the personal mobility 100 includes a body 101, a handle 110 provided on the top of the body 101, a front wheel 103F provided on the bottom of the body 101, a footrest 105 extending from the bottom of the body 101 to the rear of the front wheel 103F and a rear wheel 103R provided at the rear of the footrest 105.

The handle 110 may include a left handle 110L provided to be gripped by the driver with a left hand, and a right handle 110R provided to be gripped by the driver with a right hand.

The driver of the personal mobility 100 may stand on the footrest 105 and drive while holding the left handle 110L and right handle 110R, and manipulate the left handle 110L and right handle 110R to adjust driving direction.

A transformable unit 120 whose shape changes according to a control signal may be provided on the handle 110.

The transformable unit 120 may include a left transformable element 120L provided on the left handle 110L and a right transformable element 120R provided on the right handle 110R.

Although not shown in FIG. 1, the transformable unit 120 may include a plurality of transformable elements respectively provided in the left handle 110L and the right handle 110R.

Referring to FIG. 2, a transformable unit 120 including at least one transformable element 120F and 120B may be provided on any one of the left handle 110L and/or the right handle 110R.

The transformable unit 120 may be provided to protrude on the handle 110. That is, the transformable unit 120 may be provided to recognize a change in the shape of the transformable unit 120 by using the tactile sensation when the driver grips the handle 110.

For convenience of explanation, assuming that the side on which the driver is located is the rear side and the opposite side is the front side, the transformable unit 120 may include at least one of the front side transformable element 120F provided on the front side and the rear side transformable element 120B provided on the rear side.

The transformable unit 120 may include a plurality of front side transformable elements 120F and a plurality of rear side transformable elements 120B.

For example, referring to FIG. 3, the transformable unit 120 may include a transformable element 120B-1 located at the top of the rear side and a transformable element 120B-2 located at the bottom of the rear side.

Each of the transformable elements 120B-1 and 120B-2 may include a fixed portion fixed on the handle 110 and a transformable portion whose shape changes in a direction perpendicular to the fixed portion. The transformable portion may change shape in the vertical direction of the handle 110 rather than in the horizontal direction of the handle 110 so that the driver holding the handle 110 may feel the change in texture.

That is, the transformable unit 120 may include a fixed portion fixed on the handle 110 and a transformable portion whose shape changes in a direction perpendicular to the fixed portion.

The transformable unit 120 according to an embodiment may refer to all devices whose shape or characteristic changes according to voltage.

For example, the transformable unit 120 may be an ionic electro active polymer (EAP) whose shape changes according to voltage and/or a piezoelectric element and/or ceramic.

The ionic electro active polymer is a polymer that may be deformed by electrical stimulation, and may mean a polymer that may be repeatedly expanded, contracted, and bent by electrical stimulation. The ionic electro active polymer may include a ferroelectric polymer and/or a dielectric elastomer.

The ferroelectric polymer may be, for example, Poly VinyliDene Fluoride (PVDF) or Poly(VinyliDene Fluoride)-TriFlurorEtylene (P(VDF-TrFE)), and the dielectric elastomer may be made of silicone, urethane, acrylic, or the like.

Electrodes 121F and 121B to which voltage is applied may be provided at both ends of the transformable elements 120F and 120B, and the shape of the transformable elements 120F and 120B may change according to the voltage applied to the electrodes at both ends.

Referring to FIG. 4, a personal mobility 100 according to an embodiment may include a state sensor 160 for detecting a plurality of states of personal mobility 100, a transceiver 170 receiving the driving direction calculated based on the current position and destination of the personal mobility 100, a storage 180 for storing a plurality of shapes corresponding to a plurality of instructions for guiding the driving direction, and storing a plurality of shapes corresponding to the plurality of states of the personal mobility 100, a controller 150 for generating a control signal and sending the control signal to a transformable unit 120 to cause the transformable unit 120 to change into a shape corresponding to the instruction for guiding the driving direction received from the transceiver 170 or generating a control signal and sending the control signal to the transformable unit 120 to cause the transformable unit 120 to change into a shape corresponding to the state of the personal mobility 100 detected from the state sensor 160, and the transformable unit 120 whose shape changes according to the control signal of the controller 150.

The state sensor 160 may detect a plurality of states of personal mobility 100 and transmit the detected state to the controller 150. For example, the plurality of states of the personal mobility 100 may include at least one of a state in which one of the components of the personal mobility 100 has failed, a state in which the SoC of the personal mobility 100 is less than or equal to a preset level, a state in which the driving speed of the personal mobility 100 is more than or equal to a preset speed, or a state in which the current position of the personal mobility 100 is outside a preset area.

Specifically, a state in which one of the components of the personal mobility 100 has failed may mean a state in which one of the braking device and the acceleration device of the personal mobility 100 has failed.

The state sensor 160 for detecting this may include a detection sensor that detects whether the braking device has failed, and a detection sensor that detects whether the acceleration device has failed.

In addition, in order to detect whether the SoC of personal mobility 100 is less than or equal to the preset level, the state sensor 160 may include a battery sensor.

In addition, in order to detect whether the current position of the personal mobility 100 is a state outside the preset area, the state sensor 160 may include a Global Positioning System (GPS).

A plurality of states of the personal mobility 100 are not limited to the above example, and may be set in advance by an operator, and such a plurality of states may be stored in the storage 180. For example, the plurality of states of personal mobility 100 may include a state in which a lamp provided in the body 101 of the personal mobility 100 has failed, and the state sensor 160 for detecting this may include a current sensor for detecting a current flowing through the lamp.

The transceiver 170 may receive the driving direction calculated based on the current position and destination of the personal mobility 100 from a navigation device provided separately from the personal mobility 100 and transmit the received driving direction to the controller 150.

For this, the transceiver 170 may be implemented using a communication chip, an antenna, and related parts to access a wireless communication network. That is, the transceiver 170 may be implemented as various types of communication modules capable of short-distance communication or long-distance communication with an external navigation device.

The external navigation device may mean a navigation device provided on the user's terminal device or personal mobility 100, but may include all devices capable of receiving a destination and calculating a driving route based on the input destination and a current position of the navigation device.

The storage 180 may store a plurality of instructions for guiding a driving direction of the personal mobility 100 and a plurality of shapes corresponding to the plurality of instructions.

For example, the plurality of instructions for guiding the driving direction may include an instruction for at least one of a left turn, a right turn, a going straight, or a U-turn, and the storage 180 may store a first shape corresponding to the instruction for left turn and a second shape corresponding to the instruction for right turn.

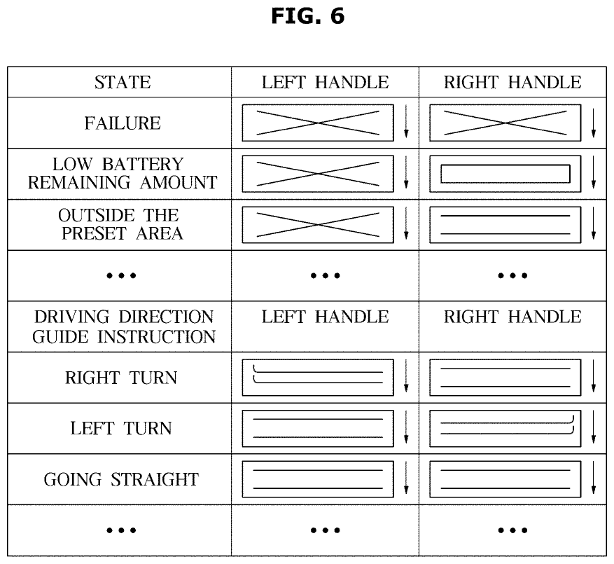

A plurality of shapes corresponding to the plurality of instructions will be described in detail with reference to FIG. 6.

In addition, the storage 180 may store a plurality of states of personal mobility 100 and a plurality of shapes corresponding to the plurality of states. For example, a third shape corresponding to a state in which the braking device for personal mobility 100 has failed, and a fourth shape corresponding to a state in which the SoC of personal mobility 100 is less than or equal to a preset level may be stored.

A plurality of shapes corresponding to the plurality of states will be described in detail with reference to FIG. 6.

The storage 180 for this may be implemented as at least one of a nonvolatile memory device such as a cache, read only memory (ROM), programmable ROM (PROM), erasable programmable ROM (EPROM), electrically erasable programmable ROM (EEPROM), and flash memory, or a volatile memory device such as a random access memory (RAM) or a storage medium such as a hard disk drive (HDD) or a CD-ROM. However, the storage 180 is not limited thereto, and any type of storage 180 may be used as long as it may store various types of information.

The controller 150 may generate a control signal and send the control signal to the transformable unit 120 to cause the transformable unit 120 to change into a shape corresponding to an instruction for guiding the received driving direction among a plurality of instructions stored in the storage 180 based on the driving direction received from the transceiver 170.

In addition, the controller 150 may generate a control signal and send the control signal to the transformable unit 120 to cause the transformable unit 120 to change to a shape corresponding to the detected state among a plurality of states stored in the storage 180 based on the state of the personal mobility 100 received from the state sensor 160.

The controller 150 may change the shape of the transformable unit 120 by applying a voltage to the electrodes 121F and 121B at both ends of the transformable unit 120.

For this, the controller 150 may include at least one memory for storing data about an algorithm for controlling the transformable unit 120 of personal mobility 100 or a program reproducing the algorithm and at least one processor for performing the above-described or later-described operation using data stored in the memory, in conjunction with the data stored in the storage 180.

When there are a plurality of memories and processors, they may be integrated on one chip, or may be provided in physically separate locations.

The storage 180 is illustrated and described separately from the controller 150, but may be included in the controller 150.

The processor may be implemented using various components such as a semiconductor chip, a switch, an integrated circuit, a resistor, a volatile or nonvolatile memory or a printed circuit board, and may be implemented using an electronic control unit (ECU).

As described above, the transformable unit 120 is provided on the handle 110 of the personal mobility 100, and its shape may change according to a control signal of the controller 150.

In addition, the transformable unit 120 may include a plurality of transformable elements according to a shape stored in the storage 180. For example, the transformable unit 120 may include a first transformable element provided on the left handle 110L and a second transformable element provided on the right handle 110R.

The role played by the controller 150 will be described in detail through a control method of personal mobility 100 and personal mobility 100 according to an embodiment of the disclosure.

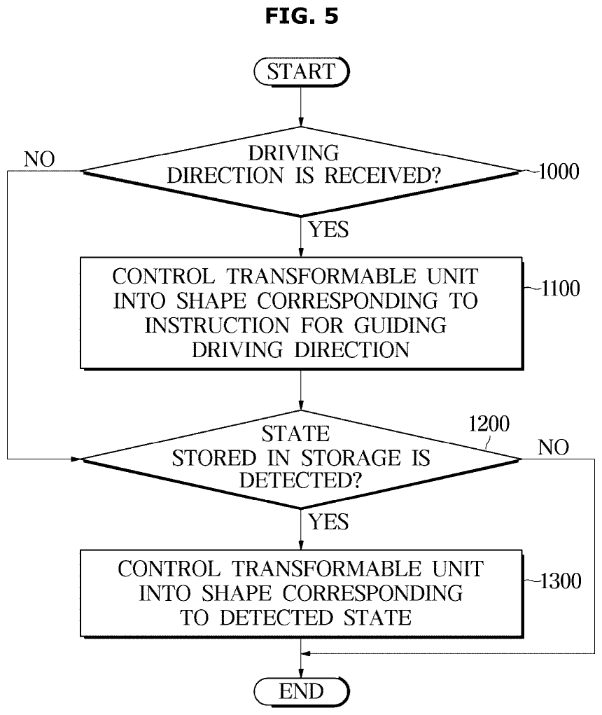

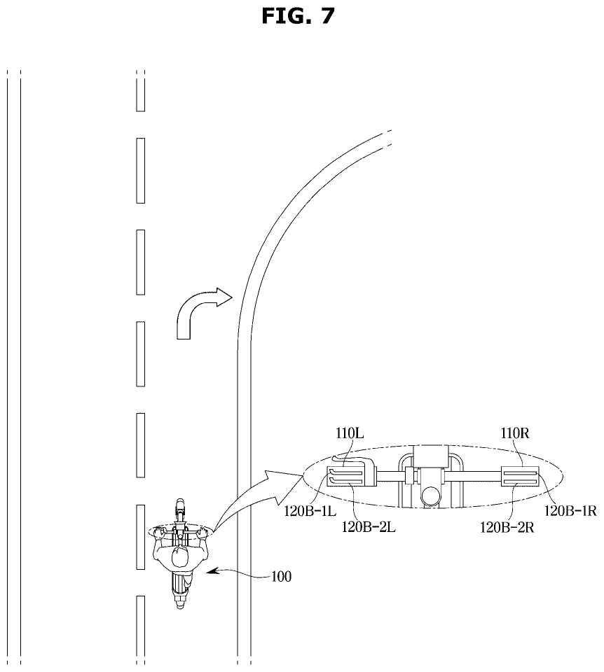

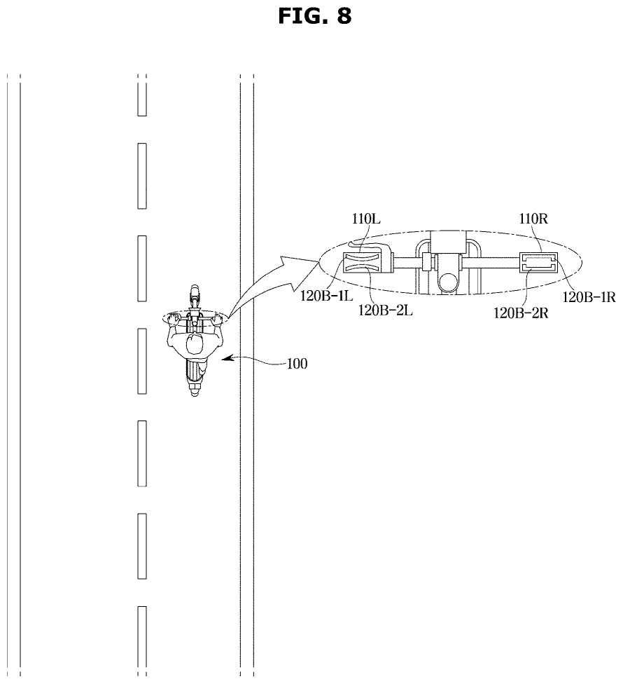

FIG. 5 is a flowchart illustrating a control method of personal mobility according to an embodiment. FIG. 6 is a diagram illustrating a plurality of shapes corresponding to a plurality of states of personal mobility and a plurality of instructions for guiding a driving direction of personal mobility. FIG. 7 is a diagram illustrating a shape of a transformable element when an instruction for right turn is received in personal mobility according to an embodiment. FIG. 8 is a diagram illustrating a shape of a transformable element when a SoC of personal mobility is insufficient according to an embodiment.

Referring to FIG. 5, the transceiver 170 may receive a driving direction calculated based on a current position and a destination of the personal mobility 100 (1000). Specifically, the transceiver 170 may receive a driving route calculated from the navigation device and a driving direction based on the driving route.

The controller 150 receives the driving direction calculated based on the current position and destination of the personal mobility 100 from the transceiver 170, and may change the transformable unit 120 into a shape corresponding to an instruction for guiding a received driving direction among a plurality of instructions stored in the storage 180 (1100). At this time, the controller 150 may determine the contact area in which the driver's hand and the transformable unit 120 are in contact based on the capacitance of the transformable unit 120, and change the shape of the transformable unit 120 within the contact area.

The controller 150 may determine the current intensity applied to the transformable unit based on the size of the contact area.

For example, the controller 150 may determine and apply a larger current intensity (or increase a current intensity) to the transformable unit 120 so as to increase the size of the texture change felt by the driver as the size of the contact area increases and may determine and apply a smaller current intensity (or reduce a current intensity) to the transformable unit 120 so as to decrease the size of a texture change felt by the driver as the size of the contact area decreases.

In addition, the controller 150 changes the shape of the transformable unit 120 within the contact area, so that the shape of the transformable unit 120 located outside the contact area may be fixed. That is, the shape of the transformable unit 120 may vary depending on which position of the handle 110 is held by the driver.

Referring to FIG. 6, a plurality of instructions stored in the storage 180 and a shape of a transformable unit 120 corresponding to each of the plurality of instructions may be confirmed.

When the driving direction transmitted from the transceiver 170 is a right turn, the controller 150 may change the transformable unit 120 into a shape corresponding to an instruction for guiding a right turn.

In this case, the transformable unit 120 may include a first transformable element 120L provided in the left handle 110L and a second transformable element 120R provided in the right handle 110R.

As shown in FIG. 6, the shape of the first transformable element 120L corresponding to the instruction for guiding the right turn may be different from the shape of the second transformable element 120R corresponding to the instruction for guiding the right turn.

However, when the driving direction received from the transceiver 170 is going straight, the controller 150 may change the transformable unit 120 into a shape corresponding to the instruction for guiding the going straight. In this case, the shape of the first transformable element 120L corresponding to the instruction for guiding the going straight may be the same as the shape of the second transformable element 120R corresponding to the instruction for guiding the going straight.

In addition, as shown in FIG. 6, the plurality of shapes corresponding to the plurality of instructions may include a static shape or a dynamic shape that changes over time.

When the plurality of shapes stored in the storage 180 are static shapes, the controller 150 may uniformly apply a voltage that enables the transformable unit 120 to maintain a static shape to the electrodes 121F and 121B provided at both ends of the transformable unit 120 without change over time.

When the plurality of shapes stored in the storage 180 are dynamic shapes, the controller 150 may apply voltages that change over time to the electrodes 121F and 121B provided at both ends of the transformable unit 120.

When a plurality of shapes stored in the storage 180 are dynamic shapes, the driver may recognize the direction of the transformable unit 120 according to the change in the shape of the transformable unit 120.

Referring to FIG. 7, when the driving direction transmitted from the transceiver 170 is a right turn, the controller 150 may change the transformable unit 120 (120B-1L, 120B-2L, 120B-1R, 120B-2R) into a shape corresponding to an instruction for guiding a right turn.

The driver may confirm that the personal mobility 100 is outputting an instruction for guiding the right turn by using the tactile sensation of the hand holding the handle 110, and accordingly, may change the driving direction to the right by manipulating the handle 110.

In this way, the driver may easily obtain information provided by the personal mobility 100 by using only the tactile sensation of the hand, and may look ahead even while obtaining the information, thereby significantly reducing the risk of an accident.

Referring back to FIG. 5, the state sensor 160 may detect the state of personal mobility 100, and the controller 150 may confirm whether at least one state among a plurality of states stored in the storage 180 is detected (1200).

When any one of the plurality of states is detected, the controller 150 may change the transformable unit 120 into a shape corresponding to the detected state (1300). At this time, the controller 150 may determine the contact area in which the driver's hand and the transformable unit 120 are in contact based on the capacitance of the transformable unit 120, and change the shape of the transformable unit 120 within the contact area.

Referring to FIG. 6, a plurality of states stored in the storage 180 and a shape of the transformable unit 120 corresponding to each of the plurality of states may be confirmed.

As shown in FIG. 6, the shape of the transformable element 120L provided on the left handle 110L corresponding to the low SoC may be different from the shape of the transformable element 120R provided on the right handle 110R corresponding to the low SoC.

However, the shape of the transformable element 120L provided in the left handle 110L corresponding to the state in which the component of personal mobility 100 has failed and the shape of the transformable element 120R provided in the right handle 110R may be the same.

In addition, the plurality of shapes corresponding to the plurality of states may include a static shape or a dynamic shape that changes over time.

When at least two of the plurality of states are detected, the controller 150 may change the transformable unit 120 into a shape corresponding to a state having a high priority among the detected at least two states.

For example, when a first state in which the braking device of personal mobility 100 has failed is detected, and at the same time, a second state in which the SoC of personal mobility 100 is less than or equal to the preset level is detected, the controller 150 may change the transformable unit 120 into a shape corresponding to the first state.

This priority may also be stored in the storage 180 and may be preset according to the intention of the operator.

When receiving the driving direction from the transceiver 170 and the state sensor 160 detects a failure state of the personal mobility 100, the controller 150 may change the transformable unit 120 into a shape corresponding to the failure state of the personal mobility 100.

That is, priority may exist between a plurality of instructions for guiding the driving direction and a plurality of states of the personal mobility 100.

For example, even if the SoC of personal mobility 100 is less than or equal to the preset level, when sufficient SoC is secured to travel to the destination, the controller 150 may change the transformable unit 120 into a shape corresponding to a plurality of instructions for guiding a driving direction.

This priority may also be stored in the storage 180 and may be preset according to the intention of the operator.

Referring to FIG. 8, when the SoC of personal mobility 100 is less than or equal to the preset level, the controller 150 may change the transformable unit 120 to a shape corresponding to a low SoC.

At this time, the transformable unit 120 may include at least one transformable element 120B-1L and 120B-2L provided in the left handle 110L and at least one transformable element 120B-1R and 120B-2R provided in the right handle 110R.

The driver may confirm that the battery of the personal mobility 100 is insufficient by using the tactile sensation of the hand holding the handle 110, and may take measures accordingly.

According to the control method of personal mobility 100 and personal mobility 100 described above, the driver may recognize various types of information through the handle 110 gripped while looking ahead, and accordingly, stability of driving may be secured.

In addition, due to the characteristics of personal mobility 100, the driver may efficiently receive various types of information when exposed to the outside.

Meanwhile, the disclosed embodiments may be implemented in the form of a recording medium storing instructions, when executed by a computer or a processor, causing the computer or the processor to perform the above described operations. The instructions may be stored in the form of a program code, and when executed by a processor, the instructions may generate a program module to perform operations of the disclosed embodiments. The recording medium may be implemented as a computer-readable recording medium.

The computer-readable recording medium may include all kinds of recording media storing commands that can be interpreted by a computer. For example, the computer-readable recording medium may be ROM, RAM, a magnetic tape, a magnetic disc, flash memory, an optical data storage device, etc.

According to the present disclosure, various information can be efficiently transmitted to a driver by controlling a transformable element provided in a handle for personal mobility.

The exemplary embodiments of the disclosure have thus far been described with reference to the accompanying drawings. It will be obvious to those of ordinary skill in the art that the disclosure may be practiced in other forms than the exemplary embodiments as described above without changing the technical idea or essential features of the disclosure. The above exemplary embodiments are only by way of example, and should not be interpreted in a limited sense.

1. A personal mobility comprising:
a handle;
a transformable unit provided on the handle and configured to change a shape according to a control signal;
a storage configured to store a plurality of shapes corresponding to a plurality of instructions for guiding a driving direction of the personal mobility; and
a controller configured to determine an area based on a capacitance of the transformable unit, and determine and send the control signal to the transformable unit to change the shape of the transformable unit within the area,
wherein the controller is configured to receive a driving direction calculated based on a current position and a destination of the personal mobility and change the transformable unit into a shape corresponding to an instruction for guiding the received driving direction among the plurality of instructions.

2. The personal mobility according to claim 1, wherein the storage is configured to store a plurality of shapes corresponding to a plurality of states of the personal mobility, and
the controller is configured to change the transformable unit into a shape corresponding to one state when the one state of the plurality of states is detected.

3. The personal mobility according to claim 2, wherein the controller is configured to change the transformable unit into a shape corresponding to a state having a higher priority among at least two states when the at least two states of the plurality of states are detected.

4. The personal mobility according to claim 2, wherein, when one of the plurality of states is detected and the driving direction calculated based on the current position and the destination of the personal mobility is received, the controller is configured to change the transformable unit into a shape corresponding to a higher priority among the detected state and the instruction for guiding the driving direction.

5. The personal mobility according to claim 1, wherein the plurality of instructions for guiding the driving direction comprises an instruction for at least one of a left turn, a right turn, a going straight, or a U-turn.

6. The personal mobility according to claim 2, wherein the plurality of states of the personal mobility comprises at least one of a state in which one of components of the personal mobility has failed, a state in which a SoC of the personal mobility is less than or equal to a preset level, a state in which a driving speed of the personal mobility is more than or equal to a preset speed, or a state in which the current position of the personal mobility is outside a preset area.

7. The personal mobility according to claim 1, wherein the handle comprises a left handle and a right handle,
the transformable unit comprises a first transformable element provided on the left handle and a second transformable element provided on the right handle, and
the controller is configured to independently change the first transformable element and the second transformable element.

8. The personal mobility according to claim 1, wherein the controller is configured to determine a current intensity applied to the transformable unit based on a size of the area.

9. The personal mobility according to claim 1, wherein the plurality of shapes corresponding to the plurality of instructions comprises at least one of a static shape or a dynamic shape that changes over time.

10. A control method of a personal mobility comprising a handle, a transformable unit provided on the handle and configured to change a shape according to a control signal and a storage configured to store a plurality of shapes corresponding to a plurality of instructions for guiding a driving direction of personal mobility, the method comprises:
determining an area based on a capacitance of the transformable unit;
receiving the driving direction calculated based on a current position and a destination of the personal mobility; and
changing the transformable unit into a shape corresponding to an instruction for guiding the received driving direction among the plurality of instructions within the area.

11. The control method according to claim 10, wherein the storage is configured to store a plurality of shapes corresponding to a plurality of states of the personal mobility, and
the control method further comprises:
detecting whether the personal mobility corresponds to one of the plurality of states; and
changing the transformable unit into a shape corresponding to the one state when the one state of the plurality of states is detected

12. The control method according to claim 11, further comprising:
changing the transformable unit into a shape corresponding to a state having a higher priority among at least two states when the at least two states of the plurality of states are detected.

13. The control method according to claim 10, wherein the changing the transformable unit comprises:
determining a current intensity applied to the transformable unit based on a size of the area.

14. A personal mobility comprising:
a handle;
a transformable unit provided on the handle and configured to change a shape according to a control signal;
a storage configured to store a plurality of shapes corresponding to a plurality of states of the personal mobility; and
a controller configured to determine an area based on a capacitance of the transformable unit, and determine and send the control signal to the transformable unit to change the shape of the transformable unit within the area, and
wherein the controller is configured to change the transformable unit into a shape corresponding to one state when the one state of the plurality of states is detected.

15. The personal mobility according to claim 14, wherein the controller is configured to change the transformable unit into a shape corresponding to a state having a higher priority among at least two states when the at least two states of the plurality of states are detected,

16. The personal mobility according to claim 14, wherein the plurality of states of the personal mobility comprises at least one of a state in which one of components of the personal mobility has failed, a state in which a SoC of the personal mobility is less than or equal to a preset level, a state in which a driving speed of the personal mobility is more than or equal to a preset speed, or a state in which the current position of the personal mobility is outside a preset area.

17. The personal mobility according to claim 14, wherein the handle comprises a left handle and a right handle,
the transformable unit comprises a first transformable element provided on the left handle and a second transformable element provided on the right handle, and
the controller is configured to independently change the first transformable element and the second transformable element.

18. The personal mobility according to claim 14, wherein the controller is configured to determine a current intensity applied to the transformable unit based on a size of the area.

19. The personal mobility according to claim 14, wherein the plurality of shapes corresponding to the plurality of states comprises at least one of a static shape or a dynamic shape that changes over time.

20. The personal mobility according to claim 1, wherein the transformable unit comprises:
a fixed portion fixed on the handle; and
a transformable portion whose shape changes in a direction perpendicular to the fixed portion.
